(19) United States
(12) Patent Application Publication
(10) Pub. No.: US 2024/0033176 A1
(43) Pub. Date: Feb. 1, 2024

(54) MASSAGE DEVICE

(71) Applicant: Zhixiang FANG, Fuzhou (CN)

(72) Inventor: Zhixiang FANG, Fuzhou (CN)

(73) Assignee: Fuzhou Miaolouli Health Technology Co., Ltd., Fuzhou (CN)

(21) Appl. No.: 18/353,206

(22) Filed: Jul. 17, 2023

(30) Foreign Application Priority Data
Jul. 26, 2022 (CN) 202221935680.2

(51) Int. Cl. A61H 23/06

(52) U.S. Cl. CPC A61H 23/06

(57) ABSTRACT

The present application relates to a massage device, including a massage stick with an adjustable length, and a massage head, where the massage head includes a massage hammer head and a massage pressure head; a head end of the massage stick is a connecting end for connecting the massage hammer head or the massage pressure head; and a tail end of the massage stick is a threaded end for externally connecting a base. The massage device has a simple structure, and is a set of massage device integrating massage pounding and massage kneading.

### TECHNICAL FIELD

The present application relates to articles for daily use, and in particular to a massage device.

### BACKGROUND

In an existing massage hammer, a hammer handle has a fixed length and is connected to a massage hammer head to play a role of a massage hammer; and in existing kneading massage, a massage stick is required to be shorter than the hammer handle, and a massage pressure head is connected to the massage stick to play a role in massaging and kneading acupuncture points. During use, the two massage devices are required, and the massage hammer and the massage and kneading are independent of each other and cannot be deformed and adapted.

### SUMMARY

In view of the shortcomings in the prior art, the technical problem to be solved by the present application is to provide a massage device.

To solve the above technical problem, the present application adopts the following technical solution: a massage device includes massage stick with an adjustable length, and a massage head, where the massage head includes a massage hammer head and a massage pressure head; a head end of the massage stick is a connecting end for connecting the massage hammer head or the massage pressure head; and a tail end of the massage stick is a threaded end for externally connecting a base.

Preferably, the massage stick is a telescopic stick.

Preferably, the massage stick is a segmented connecting stick, and at least includes a first stick body and a second stick body which are coaxially and spirally connected to each other.

Preferably, a connecting end of a head end of the telescopic stick is an external thread, and a threaded end of a tail end of the telescopic stick is an external thread. Preferably, a threaded end of a tail end of the first stick body is an external thread, a head end of the first stick body is an external thread for being spirally connected to the second stick body, a tail end of the second stick body is an internal thread for being spirally connected to the external thread of the head end of the first stick body, and a connecting end of a head end of the second stick body is an external thread or a plain shaft end.

Preferably, the massage hammer head is provided with a jack for inserting the head end of the massage stick.

Preferably, the massage pressure head is provided with an internal thread for being spirally connected to the external thread of the head end of the telescopic stick.

Preferably, the massage pressure head is provided with an internal thread for being spirally connected to the external thread of the head end of the first stick body.

Preferably, the massage pressure head is composed of a metal hard inner bone and a soft skin, and the soft skin is wrapped on an outer surface of the metal hard inner bone.

Preferably, the base is a chuck.

Compared with the prior art, the present application has the following beneficial effects: the massage device has a simple structure, and massage pounding and massage kneading are integrated into a set of massage device. When the massage hammer head is used, the massage stick is lengthened and the head end of the massage stick is connected to the massage hammer head; and when the massage pressure head is used, the massage hammer head is removed from the head end of the massage stick, and the massage stick is shortened and connected to the massage pressure head, so that the massage pressure head can be controlled by hand on an acupuncture point for kneading, and use is facilitated.

The present application will be further described in detail in combination with the accompanying drawings and the specific embodiments.

### BRIEF DESCRIPTION OF THE DRAWINGS

The drawings of the specification that constitutes a part of the present application are used to provide a further understanding of the present application. The exemplary embodiments of the present application and the description thereof are used to explain the present application, and do not constitute an improper limitation of the present application. In the drawings:

FIG. 1 is a schematic diagram of a use state of a massage hammer head according to Embodiment 1 of the present application;

FIG. 2 is a schematic diagram of a use state of a massage pressure head according to Embodiment 1 of the present application;

FIG. 3 is a schematic diagram of a use state of a scraping board according to Embodiment 1 of the present application;

FIG. 4 is a schematic diagram of a use state of a massage hammer head according to Embodiment 2 of the present application;

FIG. 5 is a first use state schematic diagram when a chuck is used under the state in FIG. 2;

FIG. 6 is a second use state schematic diagram when a chuck is used under the state in FIG. 2; and

FIG. 7 is a schematic diagram of releasing a suction force of a chuck.

### DETAILED DESCRIPTION OF THE EMBODIMENTS

The present application will be described in detail below with reference to the accompanying drawings and in conjunction with embodiments. The various examples are provided by way of interpretation of the present application and not limiting the present application. Indeed, it will be apparent to those skilled in the art that modifications and variations may be made in the present application without departing from the scope or spirit of the present application. For example, features shown or described as part of one embodiment may be used in another embodiment to produce yet another embodiment. Therefore, it is desirable that the present application includes such modifications and variations falling within the scope of the appended claims and their equivalents.

In the description of the present application, the terms “longitudinal”, “transverse”, “up”, “down”, “front”, “back”, “left”, “right”, “vertical”, “horizontal”, “top”, “bottom” and the like denote orientation or positional relationships based on those shown in the drawings and are intended for ease of description only and not to require that the present application must be constructed and operated in a particular orientation and therefore cannot be construed as limiting to the present application. The terms “connection”, “connect” and “set” used in the present application should be understood in a broad sense, for example, which may refer to a fixed connection or a detachable connection; which may refer to a direct connection or an indirect connection through intermediate components; which may refer to a wired electrical connection, a radio connection, or a wireless communication signal connection, and the specific meanings of the above terms may be understood by those of ordinary skill in the art according to a specific situation.

One or more examples of the present application are shown in the accompanying drawings. The detailed description uses numeric and alphabetic markers to refer to features in the drawings. Similar or like reference signs in the drawings and descriptions have been used to refer to similar or like parts of the present application. As used herein, the terms “first”, “second” and “third” and the like are used interchangeably to distinguish one member from another and are not intended to denote the location or importance of individual members.

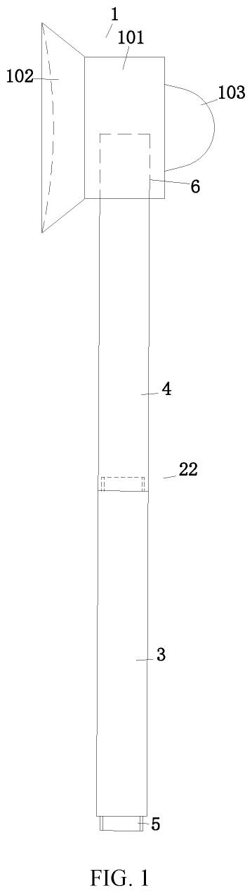

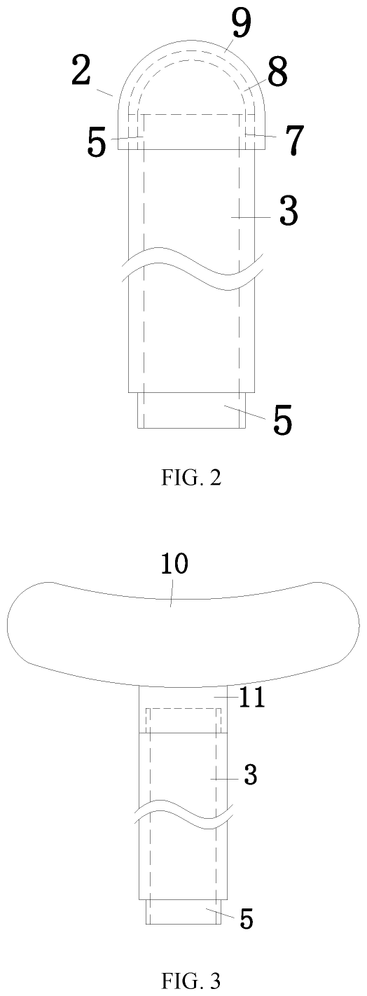

As shown in FIG. 1 to FIG. 3, Embodiment 1 provides a massage device, including a massage stick 22 with an adjustable length, and a massage head, where the massage head includes a massage hammer head 1 and a massage pressure head 2; a head end of the massage stick is a connecting end for connecting the massage hammer head or the massage pressure head; and a tail end of the massage stick is a threaded end for externally connecting a base.

In Embodiment 1 of the present application, the massage stick is a segmented connecting stick, and at least includes a first stick body 3 and a second stick body 4 which are coaxially and spirally connected to each other.

In Embodiment 1 of the present application, a threaded end of a tail end of the first stick body is an external thread 5, a head end of the first stick body is an external thread for being spirally connected to the second stick body, a tail end of the second stick body is an internal thread for being spirally connected to the external thread of the head end of the first stick body, and a connecting end of a head end of the second stick body is an external thread or a plain shaft end.

In Embodiment 1 of the present application, the massage hammer head is provided with a jack 6 for inserting the head end of the massage stick. The massage hammer head includes a base body 101 provided with a jack, a chuck-shaped flapping head 102 is fixedly arranged on one side of the base body, and a solid massage head 103 is fixedly arranged on the other opposite side of the base body. The massage hammer head is entirely made of a rubber material. Compared with the solid massage head, the chuck-shaped flapping head will be softer and less likely to cause internal injury.

In Embodiment 1 of the present application, the massage pressure head is provided with an internal thread 7 for being spirally connected to the external thread of the head end of the first stick body.

In Embodiment 1 of the present application, the massage pressure head is composed of a metal hard inner bone 8 and a soft skin 9, and the soft skin is wrapped on an outer surface of the metal hard inner bone. A massage top press end of the metal hard inner bone is semi-spherical, the shape of the soft skin is adapted to the shape of the metal hard inner bone, and the soft skin is made of rubber and other flexible materials.

In Embodiment 1 of the present application, the base is a chuck.

In Embodiment 1 of the present application, in addition to the massage hammer head and the massage pressure head, the device may further include a scraping board 10, where a connecting head 11 is fixed on the scraping board, and the connecting head is provided with an internal thread for being spirally connected to an external thread of the head end of the first stick body.

In Embodiment 1 of the present application, the working principle is: when the massage hammer head is used, the first stick body and the second stick body are coaxially and spirally connected to each other to form the massage stick, the massage stick is long, and the head end of the massage stick is in inserted connection with the massage hammer head; and when the massage pressure head is used, the massage hammer head is removed from the head end of the massage stick, the first stick body and the second stick body are disassembled, and the head end of the first stick body is connected to the massage pressure head, so that the massage pressure head can be controlled by hand on an acupuncture point for kneading, and use is facilitated. Or the head end of the first stick body is connected to the scraping board for scraping operation.

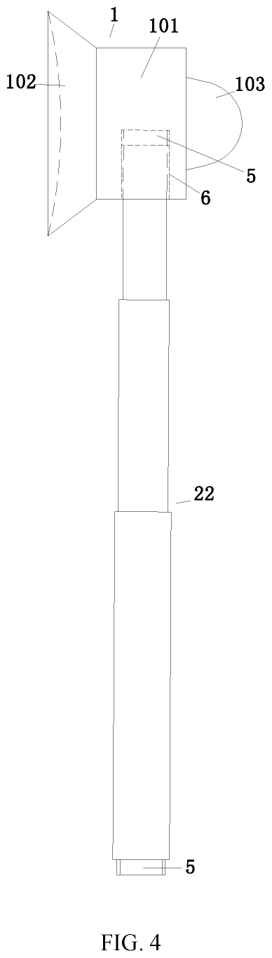

As shown in FIG. 4, the difference between Embodiment 2 of the present application and Embodiment 1 is that the massage stick is a telescopic stick. A connecting end of a head end of the telescopic stick is an external thread, and a threaded end of a tail end of the telescopic stick is an external thread. The massage pressure head is provided with an internal thread for being spirally connected to the external thread of the head end of the telescopic stick.

In Embodiment 2 of the present application, the working principle is: when the massage hammer head is used, the massage stick is extended and the head end of the massage stick is in inserted connection with the massage hammer head; and when the massage pressure head is used, the massage hammer head is removed from the head end of the massage stick, the massage stick is shrunk to the shortest, and the head end of the massage stick is connected to the massage pressure head, so that the massage pressure head can be controlled by hand on an acupuncture point for kneading, and use is facilitated. Or the head end of the massage stick is connected to the scraping board for scraping operation.

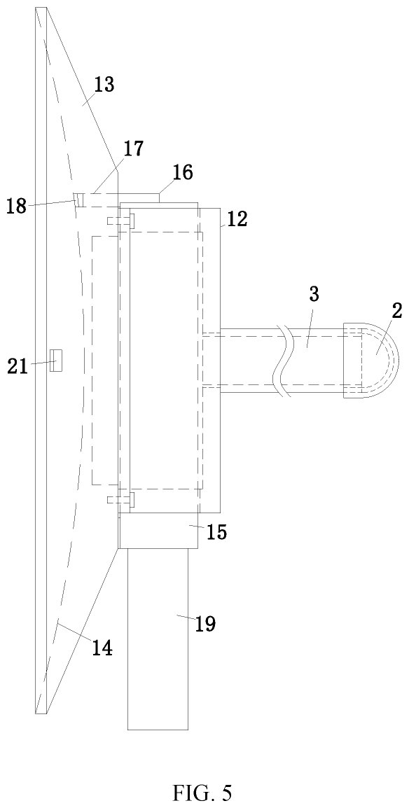

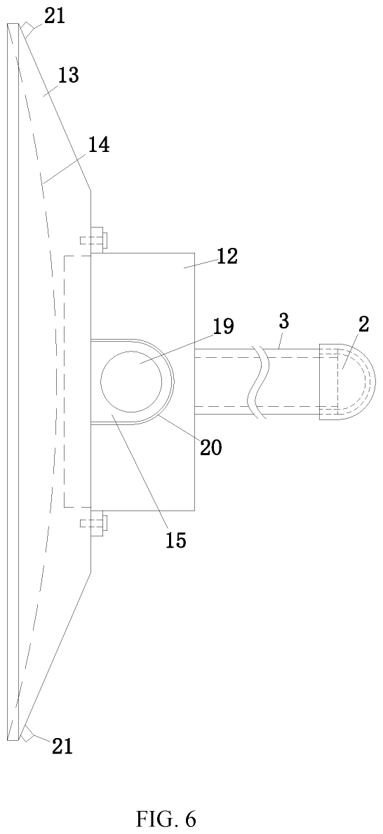

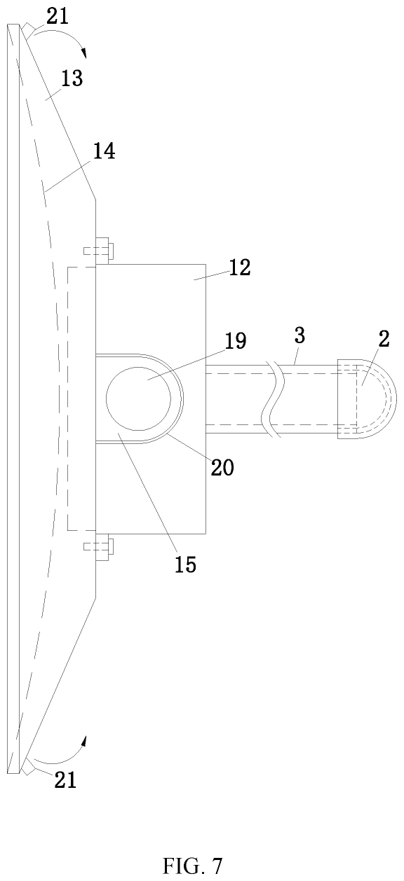

As shown in FIG. 5 to FIG. 7, in Embodiment 1 and Embodiment 2, when the massage pressure head is used for kneading acupuncture points, the massage stick can be operated by hand and can also be absorbed on a wall surface. The tail end of the massage stick is a threaded end for being externally connected to a base, and the base is a chuck. The chuck adopts a pump chuck. The tail end of the massage stick is in threaded connection with an end side of a pump cover 12 of the pump chuck, so that the massage stick is detachable, and operations such as overhaul, maintenance, change and mounting can be facilitated. An external thread is fixedly arranged at the tail end of the massage stick, the end side of the pump cover is provided with an internal threaded hole, and the internal and external threads are in threaded spiral connection; the massage stick is internally hollow; and the pump chuck includes a chuck cover 13, an adsorption surface of the chuck cover is an inner concave surface 14, the inner concave surface is a cambered surface, the internal concave surface is configured to form a negative pressure pumping space with the corresponding wall surface, and the chuck cover is provided with an air extraction pump 15 connected to the negative pressure pumping space. The chuck cover is made of rubber, and is flexible and deformable. The chuck cover is frustum-shaped. An air extraction port 16 of the air extraction pump is in inserted connection with an air extraction channel 17 formed in the chuck cover, the air extraction channel communicates with the negative pressure pumping space and is provided with a filtering sheet 18 close to the inner concave surface, and the filtering sheet adopts filter cotton for preventing other impurities such as large particles from entering the air extraction channel, thereby avoiding blockage. An end face of the chuck cover is spirally connected to the pump cover, the air extraction pump is arranged inside the pump cover on the outer end face of the chuck cover, and a pressing end 19 of the air extraction pump extends to the outside along an avoidance port 20 at the end side of the pump cover for pressing operation. The pump cover is fastened on the outer end face of the chuck cover through a screw. Two opposite convex blocks 21 are fixedly arranged on an outer conical surface of the chuck cover, and the convex bocks are close to an outer edge of the absorption surface.

During use, the adsorption surface of the chuck cover covers the wall surface, and the pressing end of the air extraction pump is pressed continuously to extract air from the negative pressure pumping space, so that the chuck cover is firmly adsorbed on the wall surface. Then, a head end is connected to the tail end of the first stick body of the massage pressure head, or the tail end of the telescopic stick is spirally connected to the internal threaded hole at the end side of the pump cover. A user can directly stand in front of the chuck and back against the massage pressure head. When the user leans back, a great massage jacking force (counter-acting force) will be generated. At the same time, the body swings left and right, the user can adjust the upper and lower range of massage by bending calves, the massage pressure head will knead the acupuncture points to massage the acupuncture points of the back, and the strength is sufficient, thereby achieving easy and labor-saving effect and good massage effect.

After massage, the user holds the massage stick with one hand, and touches the two convex blocks at the same time with two fingers of the other hand. The two fingers are closed to each other at the same time to press the two convex blocks, so that the outer edges of the absorption surfaces corresponding to the two convex blocks are deformed, some gaps are opened for the air to enter the negative pressure pumping space, and the pump chuck can be removed by releasing absorption.

As an extension of this embodiment, the pump chuck not only can be absorbed on the wall for back massage, but also can be absorbed on other planes. The massage pressure head is configured to massage palms, arms, soles and other parts. As long as the massage part is in contact with the massage pressure head conveniently is absorbed conveniently, the user can completely choose the appropriate absorption surface and the massage part by himself/herself.

The above description is only a preferred embodiment of the present application, and is not intended to limit the present application in other forms. Any person skilled in the art may change or modify the technical contents disclosed above into an equivalent embodiment with equivalent change. However, any simple amendment or equivalent change and modification of the above embodiments made according to the technical essence of the present application without departing from the content of the technical solution of the present application shall fall within the protection scope of the technical solution of the present application.

What is claimed is:

1. A massage device, comprising a massage stick with an adjustable length, and a massage head, wherein the massage head comprises a massage hammer head and a massage pressure head; a head end of the massage stick is a connecting end for connecting the massage hammer head or the massage pressure head; and a tail end of the massage stick is a threaded end for externally connecting a base.

2. The massage device according to claim 1, wherein the massage stick is a telescopic stick.

3. The massage device according to claim 1, wherein the massage stick is a segmented connecting stick, and at least comprises a first stick body and a second stick body which are coaxially and spirally connected to each other.

4. The massage device according to claim 2, wherein a connecting end of a head end of the telescopic stick is an external thread, and a threaded end of a tail end of the telescopic stick is an external thread.

5. The massage device according to claim 3, wherein a threaded end of a tail end of the first stick body is an external thread, a head end of the first stick body is an external thread for being spirally connected to the second stick body, a tail end of the second stick body is an internal thread for being spirally connected to the external thread of the head end of the first stick body, and a connecting end of a head end of the second stick body is an external thread or a plain shaft end.

6. The massage device according to claim 1, wherein the massage hammer head is provided with a jack for inserting the head end of the massage stick.

7. The massage device according to claim 4, wherein the massage pressure head is provided with an internal thread for being spirally connected to the external thread of the head end of the telescopic stick.

8. The massage device according to claim 5, wherein the massage pressure head is provided with an internal thread for being spirally connected to the external thread of the head end of the first stick body.

9. The massage device according to claim 1, wherein the massage pressure head is composed of a metal hard inner bone and a soft skin, and the soft skin is wrapped on an outer surface of the metal hard inner bone.

10. The massage device according to claim 1, wherein the base is a chuck.
